(19) United States
(12) Patent Application Publication
(10) Pub. No.: US 2017/0250757 A1
(43) Pub. Date: Aug. 31, 2017

(54) OPTICAL TRANSMITTER, OPTICAL TRANSMISSION DEVICE, AND MAPPING METHOD

(71) Applicant: FUJITSU LIMITED, Kawasaki-shi (JP)

(72) Inventors: Shuhei HATAE, Kawasaki (JP); Masato Oota, Atsugi (JP); Akiko Furuya, Yokohama (JP); Tomoki Katou, Kawasaki (JP)

(73) Assignee: FUJITSU LIMITED, Kawasaki-shi (JP)

(21) Appl. No.: 15/420,586

(22) Filed: Jan. 31, 2017

(30) Foreign Application Priority Data
Feb. 29, 2016 (JP) 2016-037399

(51) Int. Cl. H04B 10/516; H04J 14/02; H04B 10/572; H04B 10/556

(52) U.S. Cl. CPC H04B 10/5161; H04B 10/5561; H04J 14/0298; H04J 14/0257; H04B 10/572; H04L 27/3444

(57) ABSTRACT

An optical transmitter includes a signal-process circuit to process a transmission signal; an optical modulator to modulate light input by the transmission signal output from the signal-process circuit, and output an optical signal; and a control circuit to output a control signal for controlling a carrier frequency of the optical signal, to the signal-process circuit, wherein the signal-process circuit comprises a phase-rotation circuit to apply phase rotation of the carrier frequency on a complex plane according to the control signal, to the transmission signal, a map-adjustment circuit to determine scale factor for a map according to an angle of the phase rotation, and a modulation-format-map circuit to map the transmission signal on the complex plane based on a modulation format and the scale factor, wherein the phase-rotation circuit is configured to rotate, on the complex plane, the phase of the carrier frequency mapped based on the scale factor.

### CROSS-REFERENCE TO RELATED APPLICATION

This application is based upon and claims the benefit of priority of the prior Japanese Patent Application No. 2016-037399, filed on Feb. 29, 2016, the entire contents of which are incorporated herein by reference.

### FIELD

The embodiment discussed herein is related to an optical transmitter, and an optical transmission device using the optical transmitter, and a mapping method of a transmission signal.

### BACKGROUND

With an increase in data traffic, a larger capacity optical communication network is called for, and high-speed communication of 40 Gigabits per second (Gbps), 100 Gbps, or the like per wavelength is being put to practical use. Transmission and reception of an optical signal by digital signal processing has attracted attention as technology for achieving high-speed optical communication.

On the transmission side, transmission data is mapped to electric field information by a signal processing circuit, and light wave from a transmission light source is modulated and transmitted using the electric field information obtained by the mapping. Wavelength multiplexing is performed by optical signals having different wavelengths or carrier frequencies being generated and combined by plural optical transmitters.

When the oscillation frequency of the transmission light source is drifted from a desired value due to temperature variation or deterioration over time, the transmission quality is affected hindering the density of wavelength multiplexing to be raised. Therefore, a method has been proposed by which the drift in a carrier frequency is corrected in advance by the signal processing circuit (for example, see Japanese Laid-open Patent Publication No. 2012-120010). A phase rotation in the opposite direction according to the drift of the carrier frequency is applied to the electric field phase of the mapped electric field information, such that the carrier frequency is controlled. The phase rotation (angle) is defined by “θ=2πΔf·t” to the electric field phase of the symbol point, based on the frequency control amount Δf input from the carrier frequency control circuit.

A method is known in which two types of constellation maps are prepared and are switched for each transmission timing of bit data in order to reduce a peak to average power ratio (PAPR) of a multi-value optical signal (for example, see Japanese Laid-open Patent Publication No. 2014-007642). In such a method, positions of symbols in the two types of maps are restricted such that the positions do not to exceed the maximum output amplitude of an analog-to-digital converter (ADC).

Applying a phase rotation to the mapped data in advance according to the drift in the carrier frequency achieves the high-density wavelength multiplexing, thereby improving the utilization efficiency of the frequency bandwidth. However, as a result of the phase rotation processing, when a signal point exceeds an upper limit of a dynamic range, a rounding of the signal point to within the dynamic range occurs. In this case, the constellation distortion occurs and the communication performance is reduced as a transmission distance is shortened due to a reduction in the symbol position detection accuracy and a bit error rate (BER) deterioration.

### SUMMARY

According to an aspect of the invention, an optical transmitter includes: a signal-process circuit configured to process a transmission signal; an optical modulator configured to modulate light input by the transmission signal output from the signal-process circuit, and output an optical signal; and a control circuit configured to output a control signal for controlling a carrier frequency of the optical signal, to the signal-process circuit, wherein the signal-process circuit comprises a phase-rotation circuit configured to apply phase rotation of the carrier frequency on a complex plane according to the control signal, to the transmission signal, a map-adjustment circuit configured to determine scale factor for a map according to an angle of the phase rotation, and a modulation-format-map circuit configured to map the transmission signal on the complex plane based on a modulation format and the scale factor, wherein the phase-rotation circuit is configured to rotate, on the complex plane, the phase of the carrier frequency mapped based on the scale factor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating correction of a frequency drift due to phase rotation;

FIG. 2 is a diagram illustrating a problem that arises in the method of FIG. 1;

FIG. 3 is a diagram illustrating a problem that arises when applying amplitude limits to symbol points in the carrier frequency control by phase rotation;

FIG. 4 is a diagram illustrating a basic concept of map adjustment in an embodiment;

FIG. 5 is a diagram illustrating a method of the map adjustment in the embodiment;

FIG. 6 is a diagram illustrating calculation of scaling factor;

FIG. 7 is a diagram illustrating calculation of scaling factor;

FIGS. 8A and 8B are diagrams each illustrating a specific example of calculation of scaling factor for each phase rotation;

FIGS. 9A to 9C are diagrams each illustrating an example of map adjustment using scaling factor;

FIG. 10 is a diagram illustrating an example of scaling factor table according to the embodiment;

FIG. 11 is a diagram illustrating a schematic configuration of an optical transmitter according to the embodiment;

FIG. 12 is a flowchart illustrating an operation of a signal processing circuit of FIG. 11; and

FIG. 13 is a schematic diagram illustrating a wavelength multiplexing optical transmission device using plural optical transmitters according to the embodiment.

### DESCRIPTION OF EMBODIMENTS

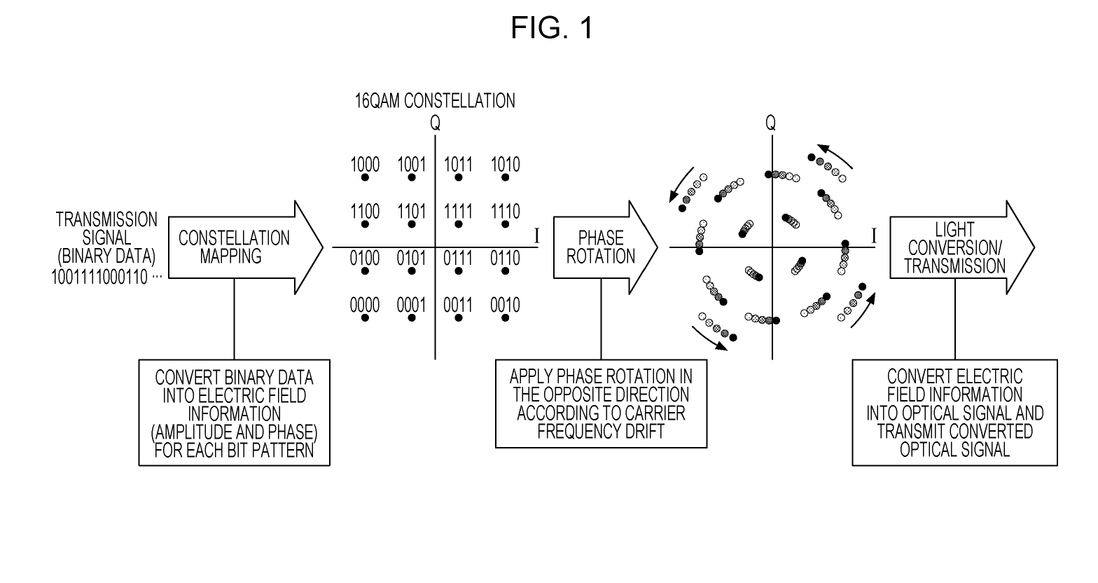

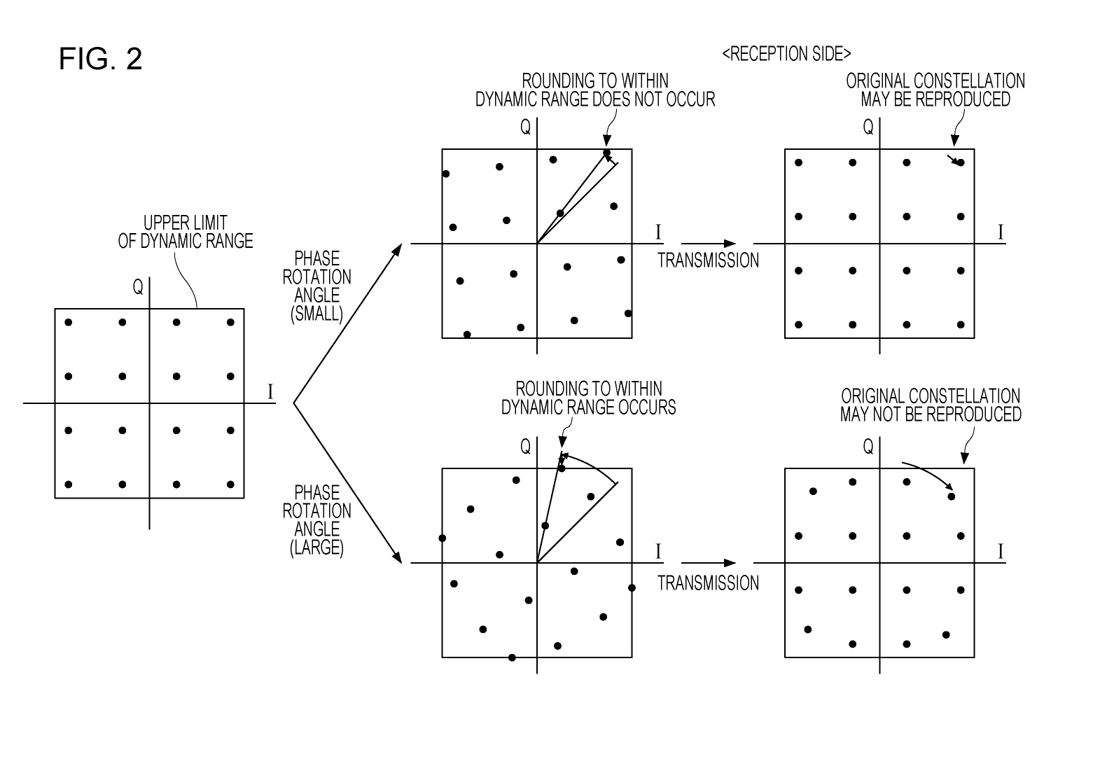

FIGS. 1 and 2 are diagrams each illustrating a problem that arises in a method in which phase rotation according to a frequency drift of a carrier wave is applied. In a signal processing circuit of an optical transmitter, a transmission signal input from the outside is mapped to electric field information in accordance with a modulation format such as quadrature phase shift keying (QPSK), quadrature amplitude modulation (QAM), or orthogonal frequency division multiplexing (OFDM). For example, when modulation of a 16 QAM scheme is performed, input data is divided into bit strings of four bits, and the bit strings are mapped to signal points (symbol points) on a complex plane (IQ plane). Such mapping is referred to as “constellation mapping”. Each of the symbol points on the constellation corresponds to electric field information determined by the amplitude and the phase.

Due to the fluctuation of the oscillation frequency of a transmission light source and the influence from the transmission path, the constellation appears to have rotated when viewed from the reception side. Therefore, correction is performed on the transmission side by rotating the phase in the opposite direction in advance. In the example of FIG. 1, the phase is rotated counterclockwise in a regular cycle. The carrier wave output from the light source is modulated by the electric field information to which the phase rotation has been applied, and transmitted as an optical signal. The light source may be configured, for example, by a semiconductor laser.

As illustrated along the upper line in FIG. 2, when a phase rotation angle applied after the mapping is small, the symbol points after the phase rotation are within the dynamic range, and the original constellation may be reproduced on the reception side.

On the other hand, as illustrated along the lower line in FIG. 2, when a phase rotation angle is large and a symbol point exceeds the upper limit of the dynamic range, rounding to the dynamic range occurs. As a result, the constellation is distorted, and a problem occurs in that the original constellation is restricted from being reproduced on the reception side. Due to the distortion of the constellation, noise rises and bit errors are increased, deteriorating the transmission characteristics.

In order to avoid the distortion of the constellation due to the phase rotation, it is conceivable to reduce the amplitude such that the trajectory of the outermost point at the time of phase rotation remains within the dynamic range. However, another problem arises.

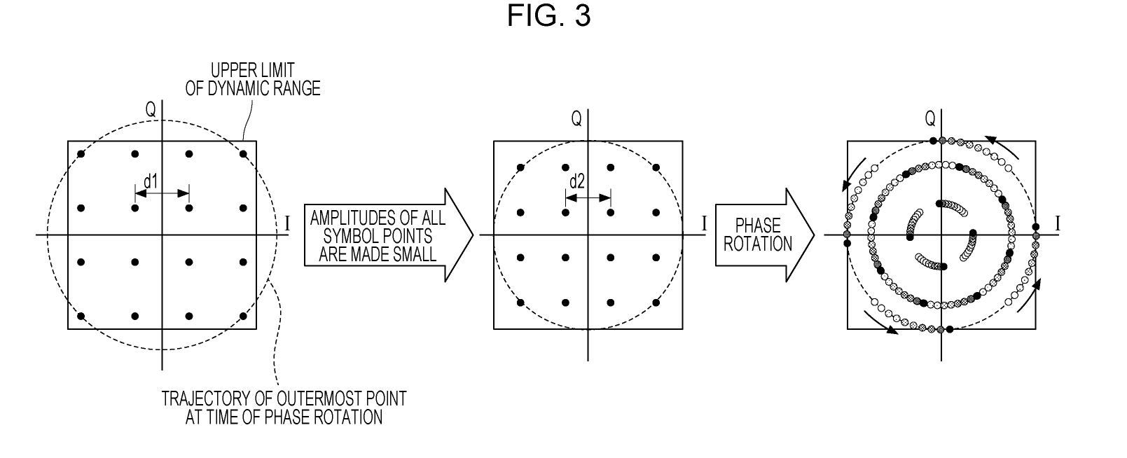

FIG. 3 is a diagram illustrating a problem that arises when the amplitude limit for symbol points is introduced for controlling a carrier frequency by the phase rotation. A distance d1 between symbols is wide in the state on the left side of FIG. 3, but the rounding to within the dynamic range occurs with the phase rotation due to a symbol point exceeding the upper limit of the dynamic range.

By reducing the amplitude in order to avoid the influence from the rounding, as illustrated in the center chart in FIG. 3, a distance d2 between the symbols is narrower than the distance d1 between the symbols before the amplitude is limited. When a phase rotation is applied in this state, constellation distortion due to the rounding will not occur. Under a condition with a favorable signal-to-noise ratio (S/N ratio), problems such as reduction in the symbol position detection accuracy and BER deterioration may be solved. For the sake of convenience, such a method is referred to as “amplitude limit method”.

However, in the amplitude limit method, under a condition with unfavorable S/N ratio, due to a reduction in the distance between the symbols, the BER is deteriorated, thereby making the transmission distance incapable of being extended.

Therefore, in the embodiment, the map adjustment is performed such that a minimum distance from another symbol is maximized at each phase rotation. In the map adjustment of the embodiment, distance between symbols is maximized for each phase rotation angle, by maintaining as much as possible the original arrangement relationship of symbols in accordance with the modulation format. By performing a mapping in which the maximum amplitude is obtained according to each phase rotation angle, when a phase rotation control is performed, an excellent transmission quality may be maintained while maintaining the utilization efficiency of the frequency bandwidth.

<Basic Concept>

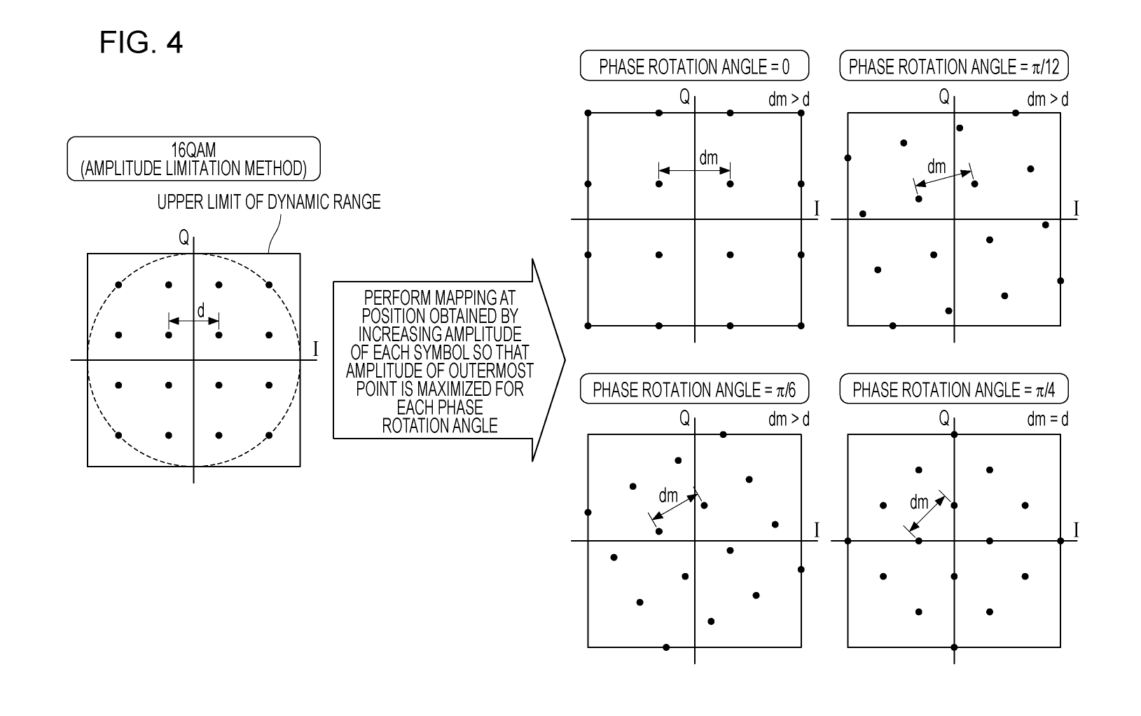

FIG. 4 is a diagram illustrating a basic concept of the map adjustment in the embodiment. In the embodiment, the mapping is adjusted such that the closest distance between symbol points is maximized for each phase rotation angle.

In FIG. 4, the chart on the left side illustrates symbol points of 16 QAM as determined by the amplitude limit method of FIG. 3. The amplitude has been reduced such that, by the phase rotation, the outermost symbols do not exceed the upper limit of the dynamic range. The distance between the symbols at this time is set as “d”.

Charts on the right side of FIG. 4 illustrate adjustment of symbol-to-symbol distance according to each phase rotation angle. Here, cases are illustrated in which the phase rotation angle are 0 radian, π/2 radian, π/6 radian, and π/4 radian respectively. In the following description, “radian” as a unit of angle is omitted as appropriate.

When no phase rotation is applied (phase rotation angle is zero), the symbol points are extended to the upper limit of the dynamic range.

This maximizes the amplitudes of each symbol points.

The distance between the symbols is extended as the amplitudes of the symbol points are maximized, thereby improving the S/N ratio.

When the phase rotation angle is π/12, distance between the symbols is adjusted at the maximum within a range in which the outermost symbol points do not exceed the upper limit of the dynamic range, while maintaining the original 16 QAM symbol arrangement as much as possible.

Similarly, when the phase rotation angles are π/6 and π/4, respectively, distance between the symbols is adjusted at the maximum within a range in which the outermost symbol points do not exceed the upper limit of the dynamic range, while maintaining the original 16 QAM symbol arrangement as much as possible. When the phase rotation angle is π/4, the trajectory of the outermost point is the smallest.

In a case in which the distance between the symbols after the map adjustment in the embodiment is set as “dm”, and when the phase rotation angles are 0, π/12, and π/6 respectively, the distance dm between the symbols after the map adjustment is larger than the symbol distance d adjusted by the amplitude limit method in FIG. 3 (dm>d). When the phase rotation angle is π/4, the distance dm is about the same as the distance d between the symbols by the amplitude limit method in FIG. 3 (dm=d).

In this manner, the distance between the symbols may be extended further than in the amplitude limit method in FIG. 3, in many cases. On average, the improvement effect on an S/N ratio and BER is larger compared with the method in FIG. 3.

The method of FIG. 4 is based on the adjustment of scaling factor according to a phase rotation amount. The scaling factor is a ratio at which the outermost symbol point is extended or reduced to the upper limit of the dynamic range when the phase rotation occurs, by setting the amplitude when the phase rotation angle is zero as the reference.

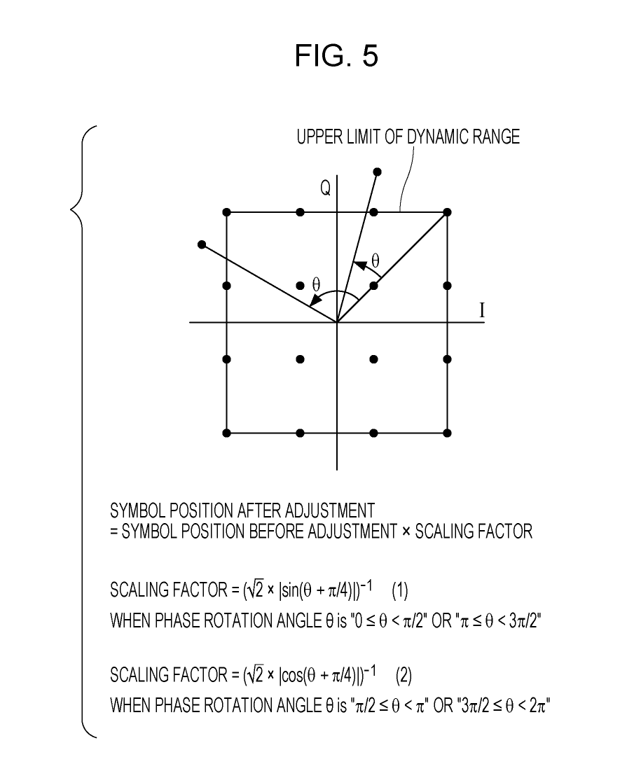

FIG. 5 is a diagram illustrating a method of the map adjustment in the embodiment. A symbol position Pa after the adjustment is obtained by multiplying the symbol position Pb before the adjustment by the scaling factor α.

Pa=Pb×α

The scaling factor varies depending on a quadrant of the constellation plane (I-Q plane) in which the phase rotation angle exists.

When the phase rotation angle θ is “0≦θ<π/2” (0°≦θ<90°) or “π≦θ<3π/2” (180°≦θ<270°), the scaling factor a is expressed by the formula (1).

α=(√2×|sin(θ+π/4)|)₋₁ (1)

When the phase rotation angle θ is “π/2≦θ<π” (90°≦θ<180°) or “3π/2≦θ<2π” (270°≦θ<π360°), the scaling factor α is expressed by the formula (2).

α=(√2×|cos(θ+π/4)|)⁻¹ (2)

Here, the range of the phase rotation angle θ is “0≦θ<2π”.

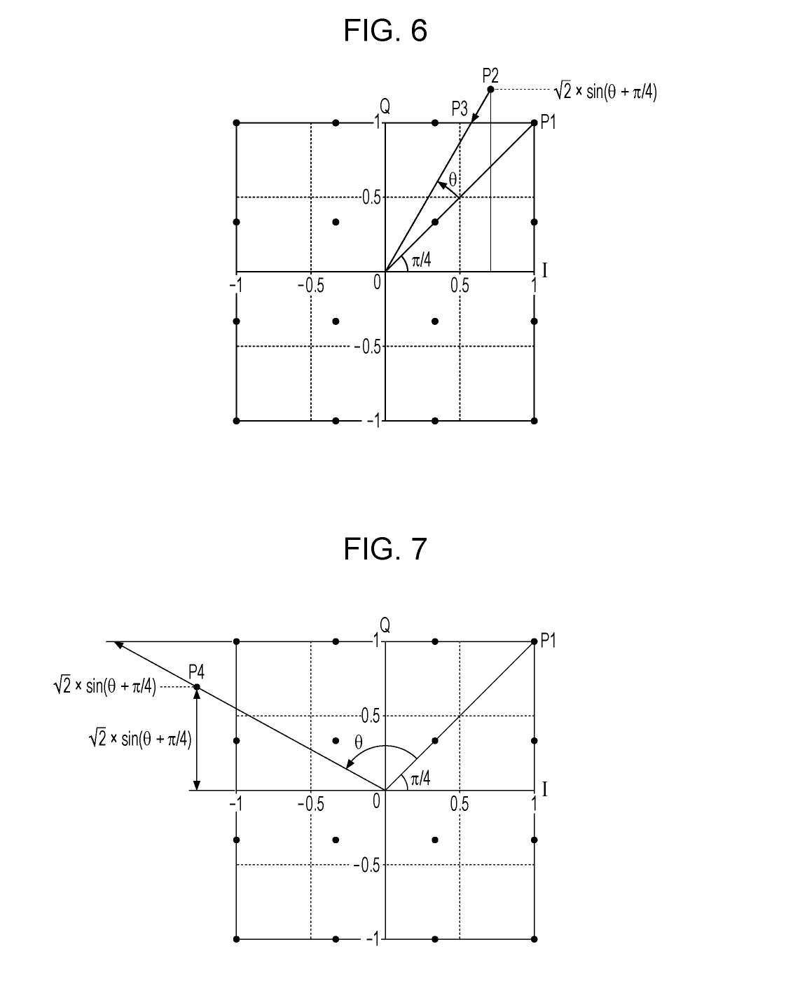

FIGS. 6 and 7 are diagrams respectively illustrating the basis of the formulas (1) and (2). FIG. 6 is a diagram illustrating calculation of scaling factor when the phase rotation angle θ is “0≦θ<π/2” (0°≦θ<90°). The constellation that has been extended up to the upper limit (±1) of the dynamic range is set as the reference for the calculation of scaling factor.

The symbol positions each indicate electric field information obtained by mapping a transmission signal on the I-Q plane in accordance with the modulation format, and are indicated by the electric field strength (amplitude) and the electric field phase.

In the first quadrant of the I-Q plane, “(I,Q) coordinates” of the outermost point P1 that is the furthest from the origin point are (1,1). A distance r to the point P1 from the origin point, namely, the amplitude is √2, and the phase is π/4.

When the phase rotation angle is set as θ, a value of the Q coordinate of position P2 after the phase rotation is “√2×sin(θ+π/4)”.

In order to keep the outermost point P1 that has moved to the position P2 within the upper limit of the dynamic range, the amplitude of P1 is reduced to the upper limit of the dynamic range. The value of the Q coordinate of position P3, after the reduction, is 1. Thus, the scaling factor α is as follows.

α=1/(√2×|sin(θ+π/4)|)

=(√2×|sin(θ+π/4)|)⁻¹ (1)

Here, “sin(θ+π/4)” is set as an absolute value because “sin(θ+π/4)” becomes a negative value (sin(θ+π/4)<0) when the phase rotation angle θ is in a range of “3π/4<θ<7π/4”.

The scaling factor a that has been obtained for the Q coordinate is also used for the I coordinate.

Next, when the phase rotation angle θ is “π/2≦θ<π” (90°≦θ<180°) or “3π/2≦θ<2π” (270°≦θ<π360°), an absolute value of the Q coordinate at the position P4 after the phase rotation of the outermost point P1 becomes less than 1, thus the calculation formula is changed. This is described below with reference to FIG. 7.

In FIG. 7, the outermost point P1 moves to the position P4 when the phase rotation angle θ (π/2≦θ<π) is applied.

When the formula (1) is applied to the position P4, the scaling factor for the Q coordinate becomes larger than 1, as follows.

“(√2×sin(θ+π4))⁻¹>1”.

This signifies that, although the symbol point has exceeded the upper limit of the dynamic range, the symbol arrangement is being further extended. Scaling factor in the I axis direction is determined in order to perform the map adjustment appropriately and keep the symbol at the position P4 within the upper limit (within the boundary of ±1) of the dynamic range.

The I coordinate of the position P4 is “√2×cos(θ+π/4)”. When the phase rotation angle θ is “π/2≦θ<π” (90°≦θ<180°) or “3π/2≦θ<2π” (270°≦θ<π360°), the above-described formula (2) is used for calculating the scaling factor α.

Specifically, a value of the I coordinate of the position P4 after the reduction is 1. Thus, the scaling factor α is as follows. α=1/(√2×|cos(θ+π/4)|)

=(√2×|cos(θ+π/4)|)⁻¹ (2)

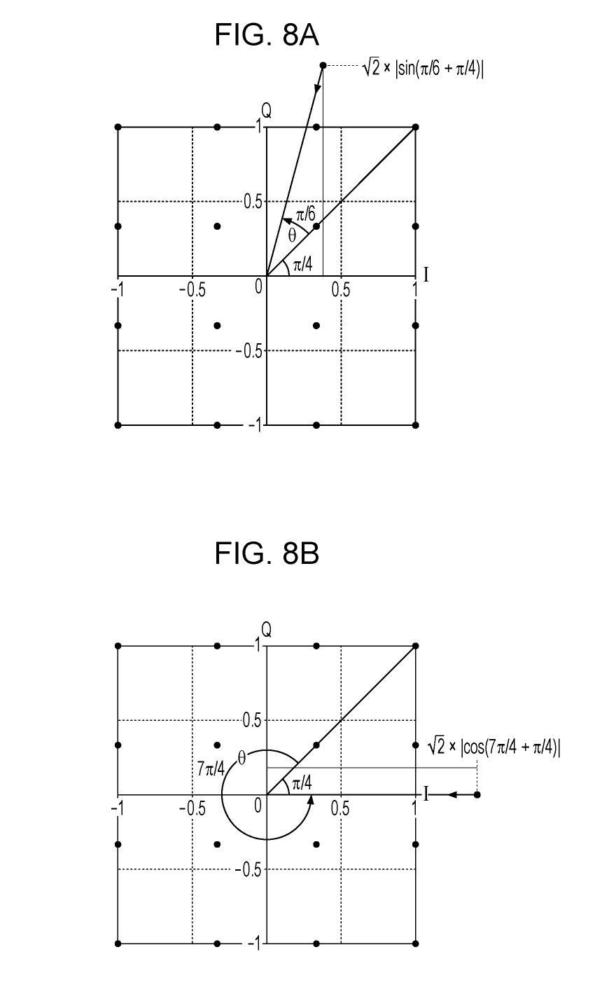

FIGS. 8A and 8B each illustrate a specific example of calculation of scaling factor for each phase rotation. FIG. 8A illustrates calculation of scaling factor when the phase rotation angle θ is π/6, and FIG. 8B illustrates calculation of scaling factor when the phase rotation angle θ is 7π/4.

In FIG. 8A, since the phase rotation angle θ is π/6 (30°) and the range of θ is “0≦θ<π/2”, the scaling factor α is calculated using the formula (1).

α=(√2×|sin(π/6+π/4)|)⁻¹

=(√2×|sin(5π/12)|)⁻¹

≅0.7320

In FIG. 8B, since the phase rotation angle θ is 7π/4 (315°) and the range of θ is “3π/2≦θ<2π”, the scaling factor a is calculated using the formula (2).

α=(√2×|cos(7π/4+π/4)|)⁻¹

=(√2×|cos(2π)|)⁻¹

=1/√2≅0.7071

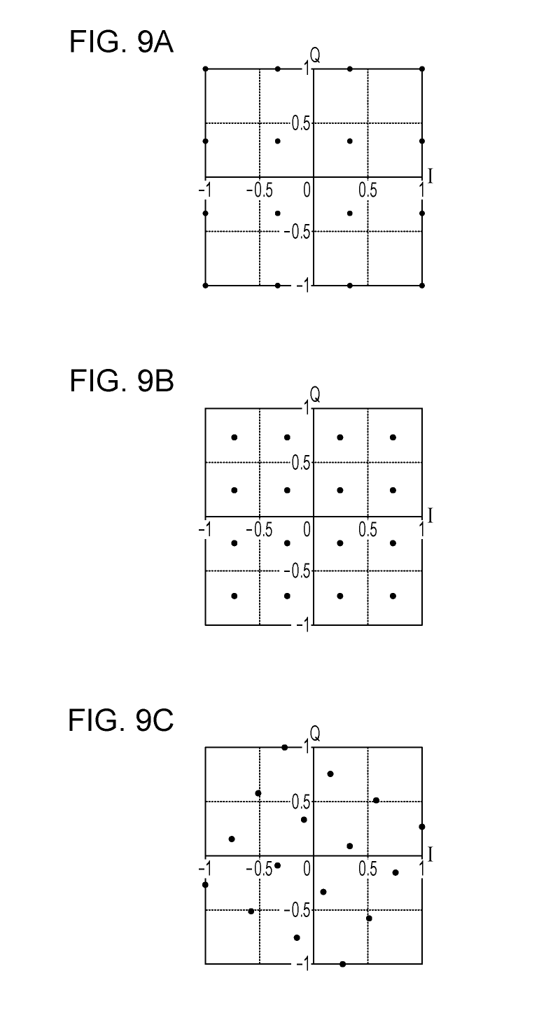

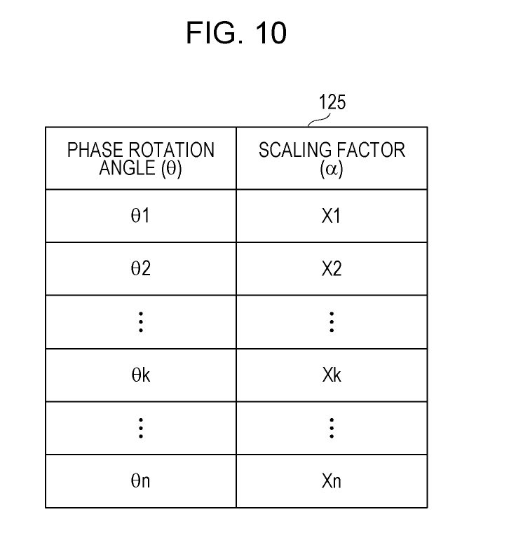

FIG. 9A to 9C each illustrates map adjustment using scaling factor α. First, in FIG. 9A, a reference constellation in accordance with a modulation format is generated. In this case, the constellation is generated in which the symbol points of 16 QAM are extended up to the upper limit of the dynamic range (±1).

Next, in FIG. 9B, a phase rotation angle θ is obtained to calculate scaling factor α, and the constellation of FIG. 9A is reduced (or expanded) according to the scaling factor α. FIG. 9B illustrates the constellation after the reduction when the phase rotation angle θ is π/6.

The phase rotation angle θ is, as described later, obtained based on a monitoring result of optical output in the optical transmitter, report of a transmission quality from the optical receiver, or a control value from the network.

Next, in FIG. 9C, the symbol points are rotated according to the phase rotation angle θ. Since the symbol positions are adjusted so as not to exceed the upper limit of the dynamic range in a state in which the original symbol arrangement is maintained, constellation distortion does not occur even after the phase rotation.

In addition, in the method of the embodiment, symbol distances of all of the symbol points are kept at a maximum, such that the S/N ratio may be favorably improved.

FIG. 10 illustrates an example of scaling factor table 125 according to the embodiment. A corresponding relationship between a phase rotation angle θ and scaling factor α is obtained in advance for each of the modulation formats (QPSK, 16 QAM, 32 QAM, 64 QAM, and the like), and recorded. The step size of θ may be set as appropriate. A change in the scaling factor is small when the step size is set too small. When the step size is set too large, a case may occur in which the symbol point exceeds the upper limit of the dynamic range due to the phase rotation. Therefore, as an example, the step size is set at 5° to 15°.

Scaling factor may be selected according to an input of a phase rotation angle without calculation, by preparing a scaling factor table 125. Alternatively, the calculation may be performed using the formula (1) or (2) each time a phase rotation angle is entered. Furthermore, any given function may be used by which a scaling factor corresponding to a phase rotation angle is obtained.

<Device Configuration>

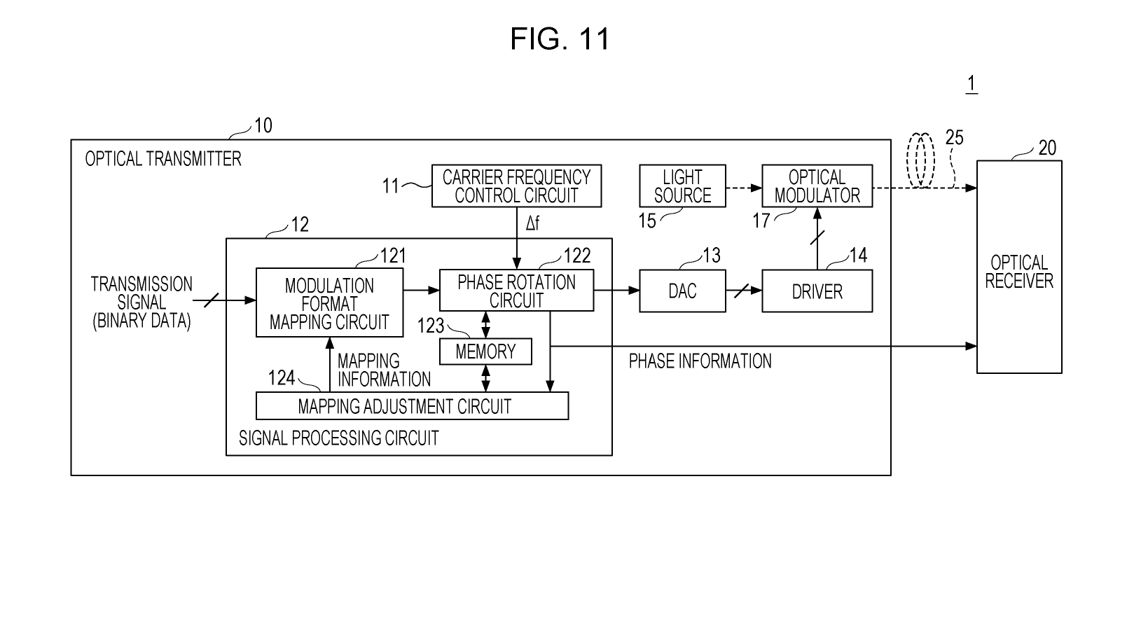

FIG. 11 is a diagram illustrating a schematic configuration of an optical transmitter 10 according to the embodiment. The optical transmitter 10 is coupled to an optical receiver 20 through an optical transmission path 25 of an optical transmission system 1. An optical signal is transmitted and received between the optical transmitter 10 and the optical receiver 20.

The optical transmitter 10 includes a carrier frequency control circuit 11, a signal processing circuit 12, a digital-analog converter (DAC) 13, a driver 14, a light source 15, and an optical modulator 17.

The light source 15 is, for example, a laser light source that oscillates output light with a certain frequency f.

The signal processing circuit 12 is, for example, a digital signal processor (DSP), and executes digital signal processing for a transmission signal that is binary data input from the outside. The signal processing circuit 12 includes a modulation format mapping circuit 121, a phase rotation circuit 122, a memory 123, and a map adjustment circuit 124. An operation of each of the circuits is described later.

The DAC 13 converts the digital signal output from the signal processing circuit 12 into an analog signal. The driver 14 generates a drive signal by amplifying the signal received from the DAC 13, and drives the optical modulator 17 by the drive signal. The optical modulator 17 modulates output light from the light source 15 with the drive signal to which transmission information has been added, and outputs the modulated output light to the optical transmission path 25 as an optical signal.

The carrier frequency control circuit 11 outputs a control signal for controlling carrier frequency of the optical signal output from the optical modulator 17. The control signal includes a frequency control amount Δf indicating a drift of the carrier frequency from a design value. The oscillation frequency of the light source 15 fluctuates due to temperature change and deterioration over time, and is drifted from the designed carrier frequency (center frequency). The frequency drift of the carrier wave has a large impact on high-density wavelength multiplexing. Therefore, the drift of the carrier frequency is corrected at the signal processing stage on the transmission side, using the frequency control amount Δf for correcting the drift of the carrier frequency.

The frequency control amount Δf may be detected by monitoring part of the output light of the optical modulator 17 and observing a drift of the center frequency. Alternatively, the frequency control amount Δf may be determined based on a quality detection result of BER, S/N ratio, and the like, obtained on the receiver side. The frequency control amount Δf is supplied to the phase rotation circuit 122 of the signal processing circuit 12.

In the signal processing circuit 12, the modulation format mapping circuit 121 performs constellation mapping of a transmission signal input from the outside, to the electric field information in accordance with the modulation format.

The phase rotation circuit 122 applies a phase rotation angle represented by “θ=2πΔf·t” to the electric field phase of the symbol point, based on the frequency control amount Δf input from the carrier frequency control circuit 11.

The phase rotation circuit 122 outputs the phase information including the phase rotation angle to the map adjustment circuit 124. The phase information is supplied to the optical receiver 20 from the optical transmitter 10 while being supplied to the map adjustment circuit 124. The frequency control amount Δf and/or the phase rotation angle may be stored in the memory 123.

When the scaling factor table 125 illustrated in FIG. 10 is stored in the memory 123, the map adjustment circuit 124 reads scaling factor corresponding to the phase rotation angle from the memory 123. Then, the map adjustment circuit 124 supplies the information including the scaling factor corresponding to the phase rotation angle to the modulation format mapping circuit 121 as mapping information. When the scaling factor table 125 is not used, the map adjustment circuit 124 may calculate scaling factor α from the phase rotation angle using the formula (1) or (2) stored in the memory 123, or another appropriate function.

It suffices if the memory 123 is not provided in the signal processing circuit 12, and may be an external memory. In addition, the scaling factor α may be included in the phase information supplied to the optical receiver 20.

The modulation format mapping circuit 121 expands or reduces the whole constellation based on the modulation format and the mapping information. As a result, mapping is performed in which the symbol points do not exceed the upper limit of the dynamic range even when the phase rotation is applied, and distances between all of the symbol points are maximized while the original symbol arrangement is maintained. The map adjustment circuit 124 after the mapping outputs the symbol information on which the map adjustment has been performed, to the phase rotation circuit 122. The phase rotation circuit 122 rotates the electric field phase by the phase rotation amount according to a frequency control amount Δf and outputs the symbol information.

As a result, when the phase rotation is applied, constellation distortion is avoided, utilization efficiency of the frequency bandwidth is increased, and the transmission quality is improved.

The optical receiver 20 is capable of reproducing the received optical signal by the received phase information. As illustrated in FIG. 11, the phase information may be transmitted from the optical transmitter 10 to the optical receiver 20, separately from the optically modulated transmission signal, or may be transmitted as a sideband of light wave superimposed with the transmission signal. Alternatively, the phase information may be included in a transmission frame of the transmission signal. In addition, a known technology in which the phase is inferred on the reception side may be used without transmitting the phase information to the optical receiver 20.

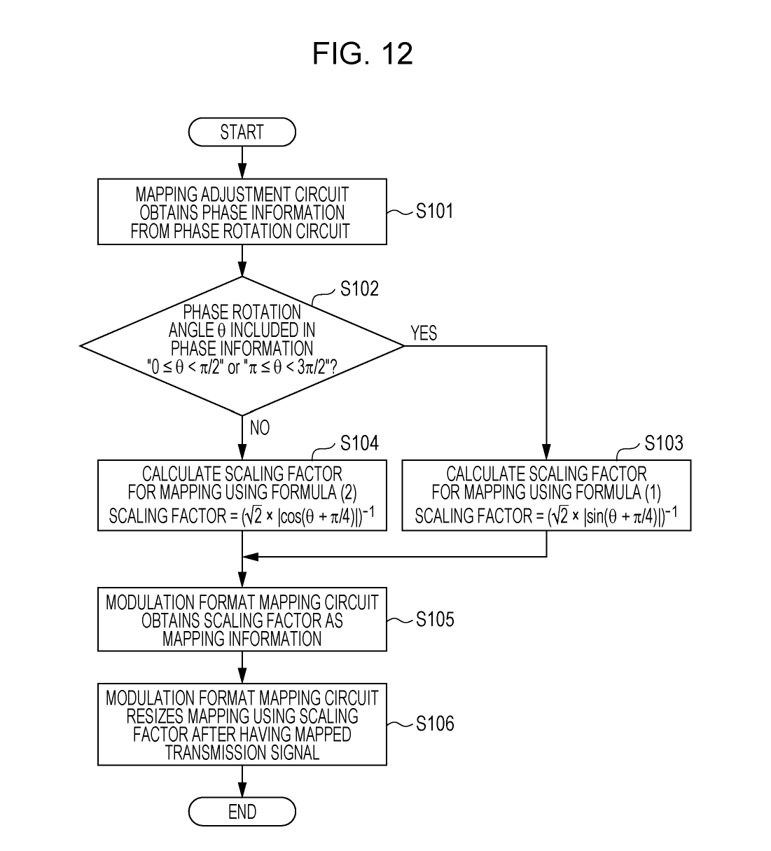

FIG. 12 is a flowchart illustrating operation of the signal processing circuit 12. First, the map adjustment circuit 124 obtains phase information from the phase rotation circuit 122 (S101).

The map adjustment circuit 124 determines whether a phase rotation angle θ included in the phase information is included in either of “0≦θ<π/2” or “π≦θ<3π/2” (S102).

When the phase rotation angle θ is included in such a range (YES in S102), scaling factor for the mapping is calculated using the formula (1) (S103). When the phase rotation angle θ is not included in the above-described range (NO in S102), scaling factor for the mapping is calculated using the formula (2) (S104).

The scaling factor calculated in S103 or S104 is supplied to the modulation format mapping circuit 121 (S105). The modulation format mapping circuit 121 resizes a transmission signal using the scaling factor after mapping the transmission signal in accordance with a modulation format (S106).

Such a map adjustment method enables the frequency bandwidth efficiency to be maintained and the transmission quality to be improved.

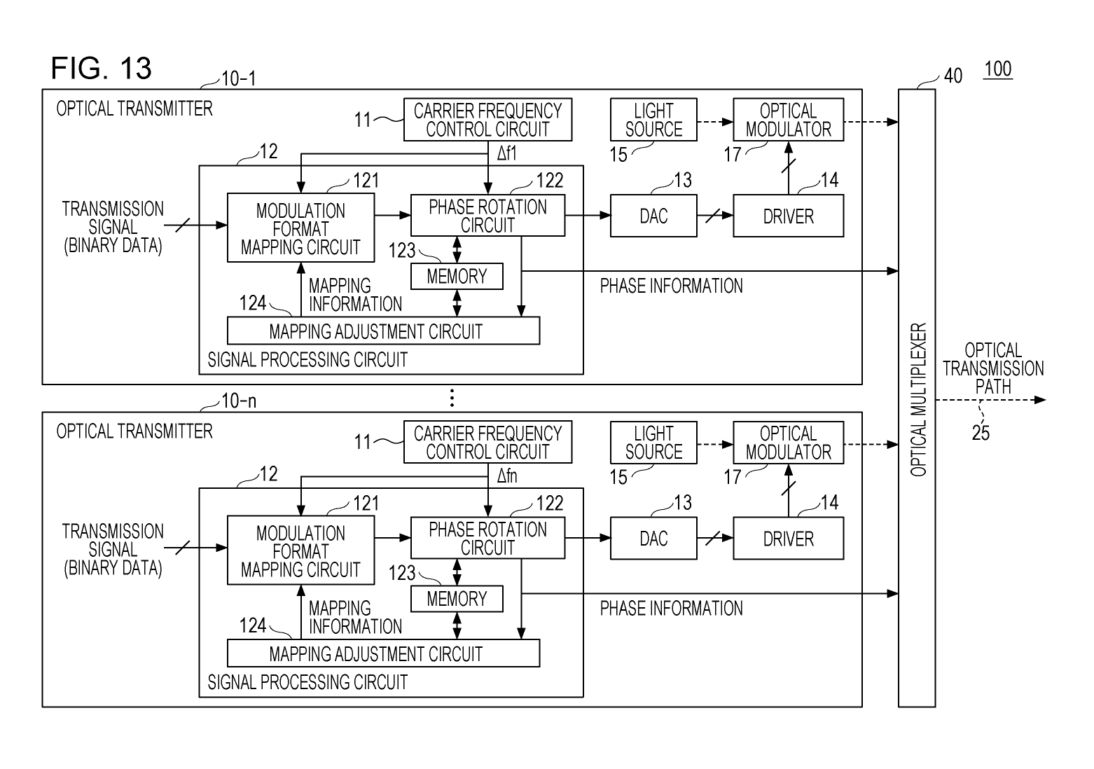

FIG. 13 is a schematic diagram illustrating a wavelength multiplexing optical transmission device 100 that uses plural optical transmitters 10 according to the embodiment. The optical transmission device 100 includes plural optical transmitters 10-1 to 10-n and an optical multiplexer 40. Each of the optical transmitters 10 is the same as the optical transmitter 10 in FIG. 11 and may be configured as an individual optical transmission chip.

In each of the optical transmitters 10, for each phase rotation angle according to a frequency control amount Δf, mapping of a modulation format is adjusted. In each of the optical transmitters 10, scaling factor according to the phase rotation angle is obtained, and the map adjustment in which the distance between symbols is maximized is performed while maintaining the arrangement relationship between the symbol points. Even when phase rotation is applied in order to compensate for a carrier frequency drift or transmission path rotation, the constellation distortion may be avoided, and an S/N ratio may be favorably maintained.

Optical signals output from the optical transmitters 10-1 to 10-n are combined by the optical multiplexer 40. At this time, by having the carrier frequency control circuits 11 of the optical transmitters 10 respectively output different frequency control amounts Δf1 to Δfn, a wavelength multiplexing is achieved in which plural optical signals having different center frequencies are multiplexed at high density using the identical type of the light sources 15. As described above, the phase rotation control and the map adjustment have been performed in advance in the optical signals to be multiplexed. This thereby enables the transmission quality to be improved while maintaining the utilization efficiency of the frequency bandwidth by narrowing the respective frequency bandwidth occupied by each carrier wave.

The preferable embodiment of the technology discussed herein is described above, however, the technology discussed herein is not limited thereto, and various modification may be performed on the technology discussed herein. For example, the technology discussed herein may also be applied to optical orthogonal frequency division multiplexing (OFDM) in which plural subcarriers are arranged in a single optical signal band at high density.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An optical transmitter comprising:
a signal-process circuit configured to process a transmission signal;
an optical modulator configured to modulate light input by the transmission signal output from the signal-process circuit, and output an optical signal; and
a control circuit configured to output a control signal for controlling a carrier frequency of the optical signal, to the signal-process circuit, wherein
the signal-process circuit further comprises
a phase-rotation circuit configured to apply phase rotation of the carrier frequency on a complex plane according to the control signal, to the transmission signal,
a map-adjustment circuit configured to determine scale factor for a map according to an angle of the phase rotation, and
a modulation-format-map circuit configured to map the transmission signal on the complex plane based on a modulation format and the scale factor, wherein
the phase-rotation circuit is configured to rotate, on the complex plane, the phase of the carrier frequency mapped based on the scale factor.

2. The optical transmitter according to claim 1, wherein
the modulation-format-map circuit is configured to resize the map using the scale factor after the transmission signal is mapped based on the modulation format.

3. The optical transmitter according to claim 1 further comprising:
a table in which a correspondence relationship of the angle of the phase rotation and the scale factor is described, wherein
the map-adjustment circuit is configured to obtain the scale factor from the table.

4. The optical transmitter according to claim 1, wherein
the map-adjustment circuit is configured to determine the scale factor using a function or a relational expression in which a relationship of the angle of the phase rotation and the scale factor is described.

5. The optical transmitter according to claim 4, wherein
the map-adjustment circuit is configured to determine the scale factor using a first relational expression when the angle of the phase rotation is in a first range, and determines the scale factor using a second relational expression when the angle of the phase rotation is in a second range different from the first range.

6. The optical transmitter according to claim 5, wherein
the map-adjustment circuit is configured to determine the scale factor using the first relational expression when the angle of the phase rotation is in a range of “0≦θ<π/2” or “π≦θ<3π/2”, and determines the scale factor using the second relational expression when the angle of the phase rotation is in a range of “π/2≦θ<π” or “3π/2≦θ<2π”.

7. The optical transmitter according to claim 5, wherein
in a case in which the phase-rotation angle is set as θ, and the scale factor is set as α, the map-adjustment circuit configured to determine the scale factor by “α=(√2×|sin(θ+π/4)|)⁻¹” when the phase-rotation angle is in the first range, and determine the scale factor by “α=(√2×|cos(θ+π/4)|)⁻¹” when the angle of the phase rotation is in the second range.

8. An optical transmission device comprising:
an optical transmitter configured to comprise
a signal-process circuit configured to execute signal-process for a transmission signal,
an optical modulator configured to modulate light input by the transmission signal output from the signal-process circuit, and output an optical signal, and
a control circuit configured to output a control signal for controlling a carrier frequency of the optical signal, to the signal-process circuit, wherein
the signal-process circuit comprises
a phase-rotation circuit configured to apply phase rotation of the carrier frequency on a complex plane according to the control signal, to the transmission signal,
a map-adjustment circuit configured to determine scale factor for a map according to an angle of the phase rotation, and
a modulation-format-map circuit configured to map the transmission signal on the complex plane based on a modulation format and the scale factor; and
a multiplexer configured to include the plurality of optical transmitters and combine optical signals that are respectively output from the plurality of the optical transmitters, wherein
the phase-rotation circuit is configured to rotate, on the complex plane, the phase of the carrier frequency mapped based on the scale factor.

9. A mapping method causing an optical transmitter to execute processing, the processing comprising:
obtaining an amount of phase rotation on a complex plane according to a carrier frequency drift of a transmission signal;
determining scale factor for adjusting map, on the complex plane, the transmission signal according to the phase-rotation amount; and
mapping the transmission signal on the complex plane based on a modulation format and the scale factor.

10. The mapping method according to claim 9, wherein
in the mapping, the map is resized using the scale factor after the transmission signal is mapped based on the modulation format.

11. The mapping method according to claim 9, wherein
the scale factor is determined using a constellation expanded up to an upper limit of a dynamic range of the optical transmitter as a reference.

12. The mapping method according to claim 9, wherein
the scale factor is determined using a first relational expression when the phase-rotation amount is in a first range, and the scale factor is determined using a second relational expression when the amount of the phase rotation is in a second range different from the first range.
